(19) United States
(12) Patent Application Publication
(10) Pub. No.: US 2017/0240676 A1
(43) Pub. Date: Aug. 24, 2017

(54) MOISTURE-CURABLE, SEMI-CRYSTALLINE (METH) ACRYLIC OLIGOMERS, AND CONSTRUCTION MATERIALS INCLUDING THE SAME

(71) Applicant: 3M INNOVATIVE PROPERTIES COMPANY, St. Paul, MN (US)

(72) Inventors: Rajdeep S. Kalgutkar, Woodbury, MN (US); Mark F. Ellis, St. Paul, MN (US); John R. Jacobsen, Woodbury, MN (US); Ramesh C. Kumar, Woodbury, MN (US); Mary L. Morris, White Bear Lake, MN (US); Michael A. Lockett, St. Paul, MN (US); Jesse R. Behnke, Maplewood, MN (US)

(73) Assignee: 3M INNOVATIVE PROPERTIES COMPANY, St. Paul, MN (US)

(21) Appl. No.: 15/591,484

(22) Filed: May 10, 2017

Related U.S. Application Data
(63) Continuation of application No. 14/648,470, filed on May 29, 2015, now abandoned.
(60) Provisional application No. 61/746,143, filed on Dec. 27, 2012.

(51) Int. Cl. C08F 220/18; C08F 220/14

(52) U.S. Cl. CPC C08F 220/18; C08F 220/14; C08F 2220/1891

(57) ABSTRACT

A composition including at least one moisture-curable, semi-crystalline (meth)acrylic oligomer represented by the formula:

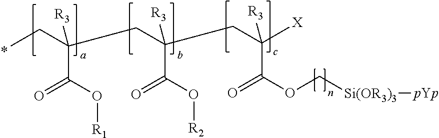

wherein R₁ is independently a C₁₆ to C₄₀ alkyl group; R₂ is independently a C₁₆ to C₄₀ alkyl group; each R₃ is independently a methyl, ethyl, or isopropyl group; X is a chain transfer agent as defined further below; Y is independently selected to be a methyl, ethyl, or isopropyl group; a, b and c are each independently selected to be an integer of at least 10, and a+b+c≦1500; n≧1; and p is 0, 1, 2, or 3. The oligomer may be used advantageously as a coating, primer or adhesion promoter in construction articles, for example, adhesives, caulks, grouts, pavement markings, paving materials, ceramic tiles, or roofing granules.

### CROSS REFERENCE TO RELATED APPLICATIONS

This application is a continuation of U.S. Pat. No. 14/648,470, filed May 29, 2015, which is a national stage filing under 35 U.S.C. 371 of International Patent Application No. PCT/US2013/028519, filed Mar. 1, 2013, which claims priority to U.S. Provisional Patent Application No. 61/746,143, filed Dec. 27, 2012, the disclosures of which are incorporated by reference herein in their entirety.

### FIELD

The present disclosure relates to moisture-curable, semi-crystalline (meth)acrylic oligomers, and more particularly to the use of such oligomers in the manufacture of construction articles, for example, roofing granules used in asphalt shingles.

### BACKGROUND

Moisture-curing polymer systems, including moisture-curing siloxane polymers (i.e. silicones), are known. Siloxane polymers have unique properties derived mainly from the physical and chemical characteristics of the siloxane bond. These properties include low glass transition temperature, thermal and oxidative stability, resistance to ultraviolet radiation, low surface energy and hydrophobicity, high permeability to many gases, and biocompatibility. The siloxane polymers, however, often lack tensile strength.

The low tensile strength of the siloxane polymers can be improved by forming block copolymers. Some block copolymers contain a “soft” siloxane polymeric block or segment and any of a variety of “hard” blocks or segments. Polydiorganosiloxane polyamides, polydiorganosiloxane polyureas, and polydiorganosiloxane polyoxamide copolymers are exemplary block copolymers. However, many of the known siloxane-based polyamide block copolymers contain relatively short segments of the polydiorganosiloxane (e.g., polydimethylsiloxane) such as segments having no greater than 30 diorganosiloxy (e.g., dimethylsiloxy) units or the amount of the polydiorganosiloxane segment in the copolymer is relatively low. That is, the fraction (i.e., amount based on weight) of polydiorganosiloxane (e.g., polydimethylsiloxane) soft segments in the resulting copolymers tends to be low. Although these block copolymers have many desirable characteristics, some of them tend to degrade when subjected to elevated temperatures such as 250° C. or higher, or are otherwise not well-suited for applications requiring weathering durability or environmental exposure.

### SUMMARY

Briefly, in one aspect, the present disclosure provides a composition comprising at least one moisture-curable, semi-crystalline (meth)acrylic oligomer represented by the formula:

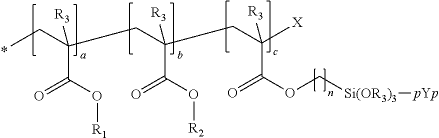

wherein:
R₁ is independently a C₁₆ to C₄₀ alkyl group;
R₂ is independently a C₁₆ to C₄₀ alkyl group;
each R₃ is independently a methyl, ethyl, or isopropyl group;
X is a chain transfer agent as defined further below;
Y is independently selected to be a methyl, ethyl, or isopropyl group;
a, b and c are each independently selected to be an integer of at least 10, and a+b+c≦1500;
n≧1; and
p is 0, 1, 2, or 3.

In any of the foregoing embodiments, n may be no greater than 1500, more preferably no greater than 20, even more preferably no greater than 18. In exemplary embodiments of any of the foregoing oligomers, the molecular weight of the oligomer is ≦5,000 Da, ≦4,000 Da, ≦3,000 Da; ≦2,000 Da; ≦1,000 Da; or even ≦500 Da.

In some exemplary embodiments of any of the foregoing oligomers, R₁ is a substituent derived from an alkyl (meth)acrylate monomer, wherein R₁ has a carbon number from 16 to 30. In certain such exemplary embodiments, R₁ is a substituent derived from an alkyl (meth)acrylate monomer wherein R₁ has a carbon number from 18 to 30.

In additional exemplary embodiments of any of the foregoing oligomers, R₂ is a substituent derived from an alkyl (meth)acrylate monomer, wherein R₂ has a carbon number from 1 to 15. In certain such exemplary embodiments, R₂ is a substituent derived from an alkyl (meth)acrylate monomer, wherein wherein R₁ has from 1 to 8.

In further exemplary embodiments, at least one R₃ is selected to be different from another R_{3.} In some exemplary embodiments, at least one R₃ is selected to be the same as another R₃. In certain exemplary embodiments, each R₃ is selected to be the same as or alternatively, different from each other R₃. In some exemplary embodiments, each R₃ is selected to be methyl.

In any of the foregoing embodiments, the composition can be substantially free of organic solvents.

In another aspect, the present disclosure provides a construction article including any of the foregoing compositions. In some exemplary embodiments, the construction article includes a substrate selected from an adhesive, a caulk, a grout, a pavement marking, a paving material, a ceramic tile, a flooring material, a wall covering, or a roofing granule.

In one particular exemplary embodiment, the substrate is a mineral roofing granule. In further exemplary embodiments, the mineral roofing granule further includes an inorganic mineral, a silicate binder, and a pigment. In another exemplary embodiment, the substrate is a manufactured glass particle roofing granule, for example, a STARLIGHT brand glass particle sold by 3M Company (St. Paul, Minn.).

In certain such embodiments, the roofing granule or manufactured glass particle is embedded in an asphalt shingle. In other exemplary embodiments, the roofing granule (which may be a mineral granule or a manufactured glass particle) is embedded in a (meth)acrylic, epoxy or urethane resin system used to adhere the granules to metal roofing, or to flat roofs.

In yet another aspect, the present disclosure provides a process for making the composition including the at least one moisture-curable, semi-crystalline (meth)acrylic oligomer, the process including (co)polymerizing a reaction mixture containing an alkyl (meth)acrylate having a carbon number from 16 to 30, an alkyl (meth)acrylate having a carbon number from 1 to 15, and an alkoxysilane compound including a (meth)acryloyl-functionality or a mercapto-functionality, wherein the alkoxy silane compound includes alkyl moieties containing from 1-3 carbon atoms. In some exemplary embodiments, the alkoxy silane compound is selected from 3-mercaptopropyl trimethoxysilane, 3-methacryloxypropyl-trimethoxysilane, and combinations thereof. In certain exemplary embodiments, (co)poly-merizing the reaction mixture comprises free radical polymerization under essentially adiabatic conditions.

In one additional aspect, the present disclosure provides a process for making any of the foregoing construction articles, including applying the moisture-curable, semi-crystalline (meth)acrylic oligomer composition to an outer surface of the construction article. In some exemplary embodiments, applying the moisture-curable, semi-crystalline (meth)acrylic oligomer composition to the outer surface of the construction article includes spraying the moisture-curable, semi-crystalline (meth)acrylic oligomer composition onto the outer surface of the construction article. In certain exemplary embodiments, the process includes heating the construction article to accelerate reaction of the moisture-curable, semi-crystalline (meth)acrylic oligomer composition with a plurality of hydroxyl groups present on the outer surface of the construction article.

Various aspects and advantages of exemplary embodiments of the present disclosure have been summarized. The above Summary is not intended to describe each illustrated embodiment or every implementation of the present disclosure. The Detailed Description that follows more particularly exemplifies certain presently preferred embodiments using the principles disclosed herein.

### DETAILED DESCRIPTION

We have invented moisture-curable, semi-crystalline (meth)acrylic oligomer compositions that can be cured to form siloxane (co)polymers. Thus, in exemplary embodiments, the present disclosure provides for moisture-curable, semi-crystalline (meth)acrylic oligomers. The oligomers may be prepared at 100% solids without added diluents or organic solvents. Use of the oligomers as reactive hydrophobic coatings for substrates, low adhesion back-sizes (LABs), and primers for low surface energy adhesives are also described.

The present disclosure also provides for cross-linked, high molecular weight siloxane block (co)polymers formed as the reaction product of the moisture-curable, semi-crystalline acrylic oligomers by hydrolysis of pendant alkoxy silane groups in the oligomers. The siloxane (co)polymers may be crosslinked or uncrosslinked, and may be elastomeric or release (co)polymers. These siloxane (co)polymers generally exhibit high hydrophobicity and water repellency while providing good adhesion to substrates, particular substrates comprising inorganic construction materials, for example roofing granules used in asphalt shingles, or aggregate used in surfacing roads. The elastomeric (co)polymers can also be used to prepare pressure sensitive adhesives by the addition of siloxane tackifying resins.

Throughout the specification, the recitation of numerical ranges by endpoints includes all numbers subsumed within that range (e.g. 1 to 5 includes 1, 1.5, 2, 2.75, 3, 3.8, 4, and 5). Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that, as used herein:

The terms “about” or “approximately” with reference to a numerical value or a shape means +/−five percent of the numerical value or property or characteristic, but expressly includes the exact numerical value. For example, a temperature of “about” 100° C. refers to a temperature from 95° C. to 105° C., but also expressly includes a temperature of exactly 100° C.

The term “substantially” with reference to a property or characteristic means that the property or characteristic is exhibited to a greater extent than the opposite of that property or characteristic is exhibited. For example, a process that is “substantially” adiabatic refers to a process in which the amount of heat transferred out of a process is the same as the amount of heat transferred into the process, with +/−5%. The terms “a”, “an”, and “the” include plural referents unless the content clearly dictates otherwise. Thus, for example, reference to a material containing “a compound” includes a mixture of two or more compounds.

The term “or” is generally employed in its sense including “and/or” unless the content clearly dictates otherwise.

The term “homogeneous” means exhibiting only a single phase of matter when observed at a macroscopic scale.

The term “non-heterogeneous” means “substantially homogeneous”.

The terms “polymer(s)” and “polymeric material” refer to both materials prepared from one monomer such as a homopolymer, or to materials prepared from two or more monomers such as a copolymer, terpolymer, or the like. Likewise, the term “polymerize” refers to the process of making a polymeric material that can be a homopolymer, copolymer, terpolymer, or the like.

The terms “copolymer(s)” and “copolymeric material” refer to a polymeric material prepared from at least two monomers. The term “copolymer” includes random, block and star (e.g. dendritic) copolymers.

The terms “(co)polymer(s)” or “(co)polymeric” includes a homopolymer and a copolymer, as well as homopolymers or copolymers that may be formed in a miscible blend, e.g., by co-extrusion or by reaction, including, e.g., transesterification.

The terms “acrylic”, “(meth)acrylic” or “(meth)acrylate” with respect to a monomer, oligomer, or substituent group all mean a vinyl-functional alkyl ester formed as the reaction product of an alcohol with an acrylic or a methacrylic acid.

The term “alkenyl” refers to a monovalent group that is a radical of an alkene, which is a hydrocarbon with at least one carbon-carbon double bond. The alkenyl can be linear, branched, cyclic, or combinations thereof and typically contains 2 to 40 carbon atoms. In some embodiments, the alkenyl contains 2 to 30, 2 to 20, 2 to 18, 2 to 16, 2 to 12, 16 to 40, 16 to 30, 16 to 20, 18 to 40, 18 to 30, 18 to 20, 20 to 40, or 20 to 30 carbon atoms. Exemplary alkenyl groups include ethenyl, n-propenyl, and n-butenyl.

The term “alkyl” refers to a monovalent group that is a radical of an alkane, which is a saturated hydrocarbon. The alkyl can be linear, branched, cyclic, or combinations thereof and typically has 1 to 30 carbon atoms. In some embodiments, the alkyl group contains contains 1 to 40, 1 to 30, 1 to 20, 1 to 18, 1 to 16, 1 to 12, 16 to 40, 16 to 30, 16 to 20, 18 to 40, 18 to 30, 18 to 20, 20 to 40, or 20 to 30 carbon atoms. Examples of alkyl groups include, but are not limited to, methyl, ethyl, n-propyl, isopropyl, n-butyl, isobutyl, tert-butyl, n-pentyl, n-hexyl, cyclohexyl, n-heptyl, n-octyl, and ethylhexyl.

The term “alkylene” refers to a divalent group that is a radical of an alkane. The alkylene can be straight-chained, branched, cyclic, or combinations thereof The alkylene often has 1 to 30 carbon atoms. In some embodiments, the alkylene contains contains 1 to 40, 1 to 30, 1 to 20, 1 to 18, 1 to 16, 1 to 12, 16 to 40, 16 to 30, 16 to 20, 18 to 40, 18 to 30, 18 to 20, 20 to 40, or 20 to 30 carbon atoms. The radical centers of the alkylene can be on the same carbon atom (i.e., an alkylidene) or on different carbon atoms.

The term “alkoxy” refers to a monovalent group of formula —OR where R is an alkyl group.

The term “halo” refers to fluoro, chloro, bromo, or iodo.

The term “haloalkyl” refers to an alkyl having at least one hydrogen atom replaced with a halo. Some haloalkyl groups are fluoroalkyl groups, chloroalkyl groups, or bromoalkyl groups.

The term “polydiorganosiloxane” refers to a divalent segment of formula

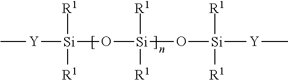

where each R¹ is independently an alkyl, haloalkyl, aralkyl, alkenyl, aryl, or aryl substituted with an alkyl, alkoxy, or halo; each Y is independently an alkylene, aralkylene, or a combination thereof; and subscript n is independently an integer of 0 to 1500.

The term “cross-linked” (co)polymer refers to a (co)polymer whose molecular chains are joined together by covalent chemical bonds, usually via cross-linking molecules or groups, to form a network (co)polymer. A cross-linked (co)polymer is generally characterized by insolubility, but may be swellable in the presence of an appropriate solvent.

The terms “room temperature” and “ambient temperature” are used interchangeably to mean temperatures in the range of 20° C. to 25° C.

The term “glass transition temperature” or “T_{g}” refers to the glass transition temperature of a (co)polymer when evaluated in bulk rather than in a thin film form. In instances where a (co)polymer can only be examined in thin film form, the bulk form T_{g} can usually be estimated with reasonable accuracy. Bulk form T_{g} values usually are determined by evaluating the rate of heat flow vs. temperature using differential scanning calorimetry (DSC) to determine the onset of segmental mobility for the (co)polymer and the inflection point (usually a second-order transition) at which the (co)polymer can be said to change from a glassy to a rubbery state. Bulk form T_{g} values can also be estimated using a dynamic mechanical thermal analysis (DMTA) technique, which measures the change in the modulus of the (co)polymer as a function of temperature and frequency of vibration.

As defined herein, by “essentially adiabatic” it is meant that total of the absolute value of any energy exchanged to or from the reaction mixture during the course of reaction will be less than about 15% of the total energy liberated due to reaction for the corresponding amount of (co)polymerization that has occurred during the time that (co)polymerization has occurred. Expressed mathematically, the essentially adiabatic criterion (for monomer poltmerization) is:

$${\int }_{{t}_{1}}^{{t}_{2}} {\sum }_{j = 1}^{N} \vert {q}_{j} ( t ) \vert dt \leq f \cdot {\int }_{{x}_{1}}^{{x}_{2}} Δ {H}_{p} ( x ) dx \qquad ( 1 )$$

where ƒ is about 0.15, ΔHₚ is the heat of (co)polymerization, x=monomer conversion=(Mₒ−M)/Mₒ where M is the concentration of the monomer and Mₒ is the initial monomer concentration, x₁ is the (co)polymer fraction at the start of the reaction and x₂ is the (co)polymer fraction due to (co)polymerization at the end of the reaction, t is the time. t₁ is the time at the start of reaction, t₂ is the time at the end of reaction, and qⱼ(t), wherein j=1 . . . N is the rate of energy transferred to the reacting system from the surroundings from all N sources of energy flow into the system.

Examples of energy transfer sources for qⱼ(t), wherein j=1 . . . N include, but are not limited to, heat energy conducted to or from the reaction mixture from the reactor jacket, energy required to warm internal components in the reaction equipment such as the agitator blades and shaft, and work energy introduced from mixing the reacting mixture. In the practice of the present disclosure, having f as close to zero as possible is preferred to maintain uniform conditions within a reaction mixture during a reaction (that is, maintain homogeneous temperature conditions throughout a reaction mixture) which helps to minimize batch-to-batch variations in a particular piece of equipment as well as minimize batch-to-batch variations when reactions are made in batch reactors of differing sizes (that is, uniform scale up or scale down of reaction).

The term “layer” means a single stratum formed between two major surfaces. A layer may exist internally within a single article, e.g., a single stratum formed with multiple strata in a single article having first and second major surfaces defining the thickness of the article. A layer may also exist in a composite article comprising multiple layers, e.g., a single stratum in a first article having first and second major surfaces defining the thickness of the article, when that article is overlaid or underlaid by a second article having first and second major surfaces defining the thickness of the second article, in which case each of the first and second articles forms at least one layer. In addition, layers may simultaneously exist within a single article and between that article and one or more other articles, each article forming a layer.

The term “adjoining” with reference to a particular first layer means joined with or attached to another, second layer, in a position wherein the first and second layers are either next to (i.e., adjacent to) and directly contacting each other, or contiguous with each other but not in direct contact (i.e., there are one or more additional layers intervening between the first and second layers).

By using terms of orientation such as “atop”, “on”, “covering”, “uppermost”, “underlying” and the like for the location of various elements in the disclosed coated articles, we refer to the relative position of an element with respect to a horizontally-disposed, upwardly-facing substrate. It is not intended that the substrate or articles should have any particular orientation in space during or after manufacture.

By using the term “overcoated” to describe the position of a layer with respect to a substrate or other element of a film of this present disclosure, we refer to the layer as being atop the substrate or other element, but not necessarily contiguous to either the substrate or the other element.

By using the term “separated by” to describe the position of a (co)polymer layer with respect to two inorganic barrier layers, we refer to the (co)polymer layer as being between the inorganic barrier layers but not necessarily contiguous to either inorganic barrier layer.

Various exemplary embodiments of the present disclosure will now be described. Exemplary embodiments of the present disclosure may take on various modifications and alterations without departing from the spirit and scope of the present disclosure. Accordingly, it is to be understood that the embodiments of the present disclosure are not to be limited to the following described exemplary embodiments, but is to be controlled by the limitations set forth in the claims and any equivalents thereof.

### Moisture-Curable, Semi-Crystalline (Meth)Acrylic Oligomers

The present disclosure describes compositions comprising one or more reactive, moisture-curable, semi-crystalline (meth)acrylic oligomers according to the general formula:

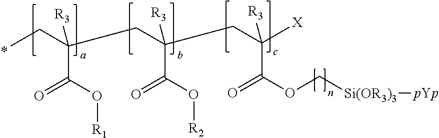

wherein:
R₁ is independently a C₁₆ to C₄₀ alkyl group;
R₂ is independently a C₁₆ to C₄₀ alkyl group;
each R₃ is independently a methyl, ethyl, or isopropyl group;
X is a chain transfer agent as defined further below;
Y is independently selected to be a methyl, ethyl, or isopropyl group;
a, b and c are each independently selected to be an integer of at least 10, and a+b+c≦1500;
n≧1; and
p is 0, 1, 2, or 3.

The value of n reflects the molecular weight of the siloxane portion of the moisture-curable semi-crystalline (meth)acrylic oligomer. The subscript n is an integer of 1 or greater. Typically, the value of n may be no greater than 1500. A wide range of n values are possible and available. For example, subscript n can be an integer up to 1000, up to 500, up to 400, up to 300, up to 200, up to 100, up to 80, up to 60, up to 50, up to 40, up to 20, or up to 10. The value of n is often at least 1, at least 2, at least 3, at least 5, at least 10, at least 20, or at least 40. For example, subscript n can be in the range of 40 to 1500, 0 to 1000, 40 to 1000, 0 to 500, 1 to 500, 40 to 500, 1 to 400, 1 to 300, 1 to 200, 1 to 100, 1 to 80, 1 to 40, or 1 to 20. It is presently preferred that n is between 1 and 20, more preferably between 1 and 18, or even more preferably between 1 and 16.

The molecular weight of the siloxane portion of the semi-crystalline (meth)acrylic oligomer(s) greatly affects the final properties of the (co)polymers prepared from the moisture-curable oligmer(s). Thus, in any of the foregoing embodiments, n may be no greater than 1500, 1,000, 500, 100, or 50. More preferably, n is no greater than 20, even more preferably no greater than 18.

The semi-crystalline (meth)acrylic oligomers are typically prepared at 100% solids, although they can also be prepared less advantageously using other technologies such as solution or dispersion polymerization (with or without subsequent inversion into water), or emulsion polymerization in water or aqueous media.

The molecular weight (i.e. weight average molecular weight, M_{w}) growth may preferably be limited by the use of reactive chain transfer agents such as, for example, 3-mercaptopropyl trimethoxysilane. This results in lower M_{w} oligomers that terminate with trialkoxysilane (e.g., trimethoxysilane) functionality, and are thus reactive with water and surfaces comprising hydroxy groups, such as most inorganic metal oxide surfaces. Thus, in exemplary embodiments of any of the foregoing oligomers, the molecular weight of the oligomer is ≦5,000 Da, ≦4,000 Da, ≦3,000 Da; ≦2,000 Da; ≦1,000 Da; or even ≦500 Da.

The use of lower M_{w} semi-crystalline (meth)acrylic oligomers is an advantage during delivery and coating of the oligomers due to the intrinsically lower viscosity of such oligomers when compared with higher M_{w} polymers. However, the weathering performance of these oligomers when used as surface coating is not compromised, since the (co)polymeric reaction product of the oligomers with surface hydroxyl groups on the substrate is chemically anchored to the substrate surface, resulting in improved adhesion of the coating to the substrate.

The oligomers can be prepared by any of the free radical polymerization techniques known to those skilled in the art. The oligomers are typically prepared by the addition polymerization of one or more ethylenically-unsaturated linear or branched (meth)acrylic monomers having a carbon number of less than 16, with one or more ethylenically-unsaturated linear (meth)acrylic monomers with a carbon number of 16 or greater, in the presence of 3-mercaptoalkyl trimethoxy silane(s), and any number of other ethylenically unsaturated co-monomers, which preferably are (meth)acrylic co-monomers.

Thus, in some exemplary embodiments of any of the foregoing oligomers, R₁ is a substituent derived from an alkyl(meth)acrylate monomer, wherein R₁ has a carbon number from 16 to 30. In certain such exemplary embodiments, R₁ is a substituent derived from an alkyl (meth)acrylate monomer wherein R₁ has a carbon number from 18 to 30.

In additional exemplary embodiments of any of the foregoing oligomers, R₂ is a substituent derived from an alkyl (meth)acrylate monomer, wherein R₂ has a carbon number from 1 to 15. In certain such exemplary embodiments, R₂ is a substituent derived from an alkyl (meth)acrylate monomer, wherein wherein R₁ has from 1 to 8.

In further exemplary embodiments, at least one R₃ is selected to be different from another R₃. In some exemplary embodiments, at least one R₃ is selected to be the same as another R₃. In certain exemplary embodiments, each R₃ is selected to be the same as or alternatively, different from each other R₃. In some exemplary embodiments, each R₃ is selected to be methyl.

Additionally, the use of (meth)acrylic monomers as the starting material for the oligomers allows the use of many different low cost commercially available monomers, thereby increasing the versatility and cost effectiveness of the oligomers as coatings for a variety of applications. Furthermore, (meth)acrylic monomers are readily available over a wide range of carbon numbers, allowing for flexible custom tailoring of the properties of the oligomers.

In some particular presently-preferred embodiments, we find it advantageous to use 100% solids polymerization methods since they provide high performance materials without the need for solvent as a processing aid. The optional use of 100% solids for the synthesis of the oligomers also improves the cost effectiveness and environmental friendliness of the synthesis process, since the use of volatile organic solvents is not required to manufacture the oligomers. In certain presently-preferred embodiments, the polymerization is carried out under essentially adiabatic conditions, most preferably at 100% solids (i.e., bulk polymerization).

Additionally, the semi-crystalline (meth)acrylic oligomers may be used in combination with other optional processing aids or performance improving additives such as organic solvents, non-reactive diluents and/or fillers. Other optional additives include chain transfer agents, ultraviolet (UV) light stabilizers, antioxidants, silane condensation catalysts, rheology modifiers, slip agents, anti-blocking agents, and the like, as described further below.

### Crystalline (Meth)Acrylate Compounds [Monomer(s) and Oligomer(s)]

The semi-crystalline (meth)acrylic oligomers include a crystalline (meth)acrylate side chain R₁ comprising one or more (co)polymerized crystalline (meth)acrylate compounds. Suitable crystalline (meth)acrylate compounds include, for example, monomers, oligomers or pre-polymers with melting transitions above room temperature (22° C.). In general, the crystalline (meth)acrylate monomers used in the reaction mixture that is (co)polymerized to form the oligomer(s) include esters of a long chain alkyl terminated primary alcohol, wherein the terminal alkyl chain is from at least 12 to about 40 carbon atoms in length, and a (meth)acrylic acid, preferably acrylic acid or methacrylic acid. The crystalline (meth)acrylate monomer is generally selected to be a C₁₂-C₄₀ alkyl ester of (meth)acrylic acid.

In some embodiments, the alkyl group contains 12 to 40, 12 to 30, 12 to 20, 12 to 18, 12 to 16, 16 to 40, 16 to 30, 16 to 20, 18 to 40, 18 to 30, 18 to 20, 20 to 40, or even 20 to 30 carbon atoms.

Suitable crystalline (meth)acrylate monomers include, for example, alkyl acrylates wherein the alkyl chain contains more than 11 carbon atoms (e.g., lauryl acrylate, tridecyl acrylate, tetradecyl acrylate, pentadecyl acrylate, hexadecyl acrylate, heptadecyl acrylate, octadecyl acrylate, nonadecyl acrylate, eicosanyl acrylate, behenyl acrylate, and the like); and alkylmethacrylates wherein the alkyl chain contains more than 11 carbon atoms (e.g., lauryl methacrylate, tridecyl methacrylate, tetradecyl methacrylate, pentadecyl methacrylate, hexadecyl methacrylate, heptadecyl methacrylate, octadecyl methacrylate, nonadecyl methacrylate, eicosanyl methacrylate, behenyl methacrylate, and the like). Presently preferred crystalline (meth)acrylate monomers include octadecyl acrylate, octadecyl methacrylate, behenyl acrylate, and behenyl methacrylate.

### Vinyl-Functional (Meth)Acrylic Co-monomer(s)

A variety of free radically (co)polymerizable co-monomers can be used in forming the side chain R₂ of the semi-crystalline (meth)acrylic oligomer(s) according to the present disclosure. Thus, in some exemplary embodiments, the free radically (co)polymerizable ethylenically-unsaturated material in the reaction mixture used to form the oligomer(s) is comprised of vinyl-functional monomers, more preferably, vinyl-functional (meth)acrylate monomers.

The identity and relative amounts of such components are well known to those skilled in the art. Particularly preferred among (meth)acrylate monomers are alkyl (meth)acrylates, preferably a monofunctional unsaturated acrylate ester of a non-tertiary alkyl alcohol, wherein the alkyl group contains 1 to about 17 carbon atoms, more preferably 1 to 12 carbon atoms, even more preferably 1 to 10 carbon atoms. Included within this class of monomers are, for example, isooctyl acrylate, isononyl acrylate, 2-ethylhexyl acrylate, decyl acrylate, dodecyl acrylate, n-butyl acrylate, hexyl acrylate, octadecyl acrylate, 2-methyl butyl acrylate, and mixtures thereof.

In some exemplary embodiments, the monofunctional unsaturated (meth)acrylate esters of a non-tertiary alkyl alcohol are selected from the group consisting of isooctyl acrylate, isononyl acrylate, 2-ethylhexyl acrylate, 2-octyl acrylate, 3-octyl acrylate, 4-octyl acrylate, decyl acrylate, dodecyl acrylate, n-butyl acrylate, hexyl acrylate, methyl acrylate, ethyl acrylate, butyl acrylate, methyl methacrylate, N-butyl methacrylate, 2-methyl butyl acrylate, and mixtures thereof.

In certain exemplary embodiments, the free radically (co)polymerizable ethylenically-unsaturated monomers are comprised of difficult to (co)polymerize monomers selected from N-vinyl pyrrolidone, N,N-dimethyl acrylamide, (meth)acrylic acid, acrylamide, N-octyl acrylamide, styrene, vinyl acetate, and combinations thereof.

Optionally, polar (co)polymerizable monomers can be (co)polymerized with the (meth)acrylate monomers to improve adhesion of the final adhesive composition to metals and also improve cohesion in the final adhesive composition. Strongly polar and moderately polar (co)polymerizable monomers can be used.

Strongly polar (co)polymerizable monomers include but are not limited to these selected from the group consisting of (meth)acrylic acid, itaconic acid, hydroxyalkyl acrylates, cyanoalkyl acrylates, acrylamides, substituted acrylamides, and mixtures thereof. A strongly polar (co)polymerizable monomer preferably constitutes a minor amount, for example, up to about 25 weight % of the monomer, more preferably up to about 15 weight %, of the monomer mixture. When strongly polar (co)polymerizable monomers are present, the alkyl acrylate monomer generally constitutes a major amount of the monomers in the acrylate-containing mixture, for example, at least about 75% by weight of the monomers.

Moderately polar (co)polymerizable monomers include, but are not limited to, those selected from the group consisting of N-vinyl pyrrolidone, N,N-dimethyl acrylamide, acrylonitrile, vinyl chloride, diallyl phthalate, and mixtures thereof. A moderately polar (co)polymerizable monomer preferably constitutes a minor amount, for example, up to about 40 weight %, more preferably from about 5 weight % to about 40 weight %, of the monomer mixture. When moderately polar (co)polymerizable monomers are present, the alkyl acrylate monomer generally constitutes at least about 60 weight % of the monomer mixture.

### Alkoxy Silane(s)

The semi-crystalline (meth)acrylic oligomer(s) includes an alkoxy silane moiety formed by reacting an alkoxy silane compound with the reaction intermediate formed by (co)polymerizing the crystalline (meth)acrylate compound(s) with the (meth)acrylic co-monomer(s). Although the semi-crystalline (meth)acrylic oligomers are represented above as being comprised of a tri-alkoxy silane moiety, in some exemplary embodiments, the (meth)acrylic oligomers may be comprised of di-alkoxy or mono-alkoxy moieties. In such exemplary embodiments, one or two of the OR₃ moieties may be replaced by an alkyl or aryl group.

Generally there are two classes of moisture-curable alkoxy silane groups that are commercially, and therefore readily, available. In one class, two of the OR₃ groups are alkoxy groups and the other OR₃ group is replaced by an alkyl or aryl group. In the other readily available class, the OR₃ groups are the same and therefore all are alkoxy groups.

Examples of suitable moisture-curable alkoxy silane groups —SiR⁴R⁵R⁶ include, —Si(OMe)₃, —Si(OEt)₃, —Si(OPr)₃, —Si(OMe)₂Me, —Si(OEt)₂Me, —Si(OMe)₂Et, —Si(OEt)₂Et, —Si(OPr)₂Me, and the like, where Me=methyl, Et=ethyl and Pr=propyl (preferably isopropyl).

One presently-preferred tri-alkoxy silane is 3-mercaptopropyl trimethoxysilane, commercially available as A-189 from Alfa Aesar, Inc. (Ward Hill, Mass.). Another useful tri-alkoxy silane is 3-Methacryloxypropyltrimethoxysilane, commercially available as A-174 from Alfa Aesar, Inc. (Ward Hill, Mass.).

Alkoxy silanes are known to be useful as moisture-curing cross-linkers, adhesion promoters and filler coupling agents. Alkoxy silanes are subject to reaction with water to form silanol groups as shown in Reaction Scheme A. These silanol groups further condense to form —Si—O—Si— bonds. As can be seen from the reactions of Reaction Scheme A (wherein R′ and R^{c} represent alkyl, aralkyl or aryl groups) the overall transformation is catalytic in water (as much water is produced as is consumed) and generates an equivalent of an alcohol.

X—SiR′₂OR^{c}+H₂O→X—SiR′₂OH+HOR^{c}

2X—SiR′₂OH→X—SiR′₂—O—SiR′₂—X+H₂O Reaction Scheme A

The organofunctional group (X) reacts with organic groups or polymers. The silane end contains alkoxy groups (OR) that are activated (hydrolyzed) by reaction with ambient moisture to form silanol groups:

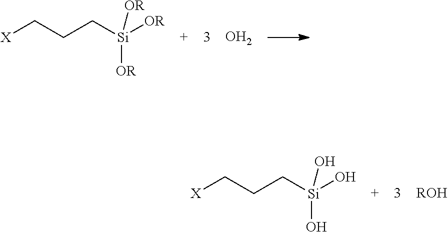

The silanol groups will condense with other silanols to form covalent bonds:

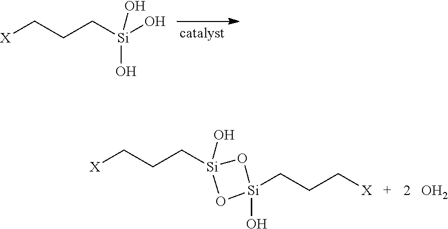

The silanol groups will also condense with reactive groups such as SiOH, AlOH or other metal oxides and hydroxides on the surfaces of fillers or substrates. Silanol groups generally form excellent bonds with the surfaces of silica, quartz, glass, aluminum and copper and form good bonds with the surfaces of mica, talc, inorganic oxides and (oxidized) steel or iron.

### Free Radical Initiators

In some presently preferred embodiments, the oligomer is formed by co-polymerizing the crystalline (meth)acrylate monomer R₁ and the crystalline (meth)acrylate compound(s) in the presence of a free radical initiator. Useful initiators in the polymerization method of the present disclosure are well known to practitioners skilled in the art and are detailed in Chapters 20 & 21 Macromolecules, Vol. 2, 2nd Ed., H. G. Elias, Plenum Press, 1984, New York.

Many possible thermal free radical initiators are known in the art of vinyl monomer polymerization and may be used in this disclosure. Typical thermal free radical polymerization initiators which are useful herein include, but are not limited to, organic peroxides, organic hydroperoxides, azo-group initiators which produce free radicals, peracids, and peresters.

Useful organic peroxides include but are not limited to compounds such as benzoyl peroxide, cumyl peroxide, tert-butyl peroxide, cyclohexanone peroxide, glutaric acid peroxide, lauroyl peroxide, methyl ethyl ketone peroxide, hydrogen peroxide, di-t-amyl peroxide, t-butyl- peroxy benzoate, 2,5-dimethyl-2,5Di-(t-butylperoxy)hexane, 2,5-dimethyl-2,5-Di-(t-butyl-peroxy)hexyne-3, and di-cumyl peroxide.

Useful organic hydroperoxides include but are not limited to compounds such as t-amyl hydroperoxide, t-butyl hydroperoxide, and cumene hydroperoxide.

Useful azo compounds include but are not limited to 2,2-azo-bis-(isobutyronitrile), dimethyl 2,2′-azo-bis-(isobutyrate), azo-bis-(diphenyl methane), 4-4′-azo-bis-(4-cyano-pentanoic acid), 2,2′-azobis(2,4-dimethylpentanenitrile), 2,2′-azobis(2-methyl-propanenitrile), 2,2′-azobis(2-methylbutanenitrile), and 2,2′-azobis-(cyclohexanecarbonitrile).

Useful peracids include but are not limited to peracetic acid, perbenzoic acid, and potassium persulfate.

Useful peresters include but are not limited to diisopropyl percarbonate.

Certain of these initiators (in particular the peroxides, hydroperoxides, peracids, and peresters) can be induced to decompose by addition of a suitable catalyst rather than thermally. This redox method of initiation is described in Elias, Chapter 20.

Preferably, the initiator used comprises a thermally decomposed azo or peroxide compound for reasons of solubility and control of the reaction rate. Most preferably, the initiator used comprises an azo initiator for reasons of cost and appropriate decomposition temperature. Useful azo compound initiators include but are not limited to the VAZO compounds manufactured by DuPont, such as VAZO 52 (2,2′-azobis(2,4-dimethylpentanenitrile)), VAZO 64 (2,2′-azobis(2-methylpropanenitrile)), VAZO 67 (2,2′-azobis(2-methylbutanenitrile)), and VAZO 88 (2,2′-azobis(cyclohexanecarbonitrile)), all available from E.I. DuPont deNemours Corp. (Wilimington, Del.).

When the initiator(s) have been mixed into the monomers, there will be a temperature above which the mixture begins to react substantially (rate of temperature rise typically greater than about 0.1° C./min for essentially adiabatic conditions). This temperature, which depends on factors including the monomer(s) being reacted, the relative amounts of monomer(s), the particular initiator(s) being used, the amounts of initiator(s) used, and the amount of any polymer, non-reactive diluent or filler, and/or any solvent in the reaction mixture, will be defined herein as the “runaway onset temperature”.

As an example, as the amount of an initiator is increased, its runaway onset temperature in the reaction mixture will decrease. At temperatures below the runaway onset temperature, the amount of polymerization proceeding will be practically negligible. At the runaway onset temperature, assuming the absence of reaction inhibitors and the presence of essentially adiabatic reaction conditions, the free radical polymerization begins to proceed at a meaningful rate and the temperature will start to accelerate upwards, commencing the runaway reaction.

According to the present disclosure, a sufficient amount of initiator(s) typically is used to carry the polymerization to the desired temperature and conversion. If too much initiator(s) is used, an excess of low molecular weight polymer will be produced thus broadening the molecular weight distribution. Low molecular weight components can degrade the oligomer composition performance. If too little initiator is used, the polymerization will not proceed appreciably and the reaction will either stop or will proceed at an impractical rate.

The preferred amount of an individual initiator used depends on factors including its efficiency, its molecular weight, the molecular weight(s) of the monomer(s), the heat(s) of reaction of the monomer(s), the types and amounts of other initiators included, etc. Typically the total initiator amount used is in the range of about 0.0005 weight % to about 0.5 weight % and preferably in the range of about 0.001 weight % to about 0.1 weight % based on the total weight of monomer(s).

### Optional Additives

In any of the foregoing embodiments, one or more additives may optionally be added to the composition. Such optional additives include, for example, organic solvents, non-reactive diluents and/or fillers.

Organic Solvents

As indicated previously, the use of an organic solvent is optional in the polymerization method of the present disclosure. In some exemplary embodiments, an organic solvent may be advantageously used for reasons of decreasing the viscosity during the reaction to allow for efficient stirring and heat transfer. The organic solvent, if used in the free radical polymerization, may be any substance which is liquid in a temperature range of about −10° C. to about 50° C., has a dielectric constant above about 2.5, does not interfere with the energy source or catalyst used to dissociate the initiator to form free radicals, is inert to the reactants and product, and will not otherwise adversely affect the reaction.

Organic solvents useful in the polymerization process typically possess a dielectric constant greater than about 2.5. The requirement that the organic solvent possess a dielectric constant above about 2.5 is to ensure that the polymerization mixture remains substantially homogeneous during the course of the reaction, allowing for the desired reaction between the siloxane macromer, the crystalline (meth)acrylate monomer, the initiator and any optional free radically polymerizable polar monomer, to occur.

Preferably, the organic solvent is a polar organic solvent having a dielectric constant ranging from about 4 to about 30 for in order to provide the best solvating power for the polymerization mixture.

Suitable polar organic solvents include but are not limited to esters such as ethyl acetate, propyl acetate and butyl acetate; ketones such as methyl ethyl ketone and acetone; alcohols such as methanol and ethanol; and mixtures of one or more of these. A presently preferred organic solvent is ethyl acetate.

Other organic solvents may also be useful in combination with these polar organic solvents. For example, although aliphatic and aromatic hydrocarbons are not generally useful by themselves as solvents, since they may lead to the precipitation of the vinyl polymeric segment from solution, resulting in a non-aqueous dispersion polymerization, such hydrocarbon solvents may be useful when admixed with other more polar organic solvents, provided that the net dielectric constant of the mixture is greater than about 2.5.

The amount of organic solvent, if used, is generally about 30 to 80 percent by weight (wt. %) based on the total weight of the reactants and solvent. Preferably, the amount of organic solvent (if used) ranges from about 40 to about 65 wt. % based upon the total weight of the reactants and solvent for reasons of yielding fast reaction times and high molecular weight at appropriate product viscosities. In some exemplary embodiments, the organic solvent is present in an amount from about 40 wt. % to about 80 wt. % of the composition. In such exemplary embodiments, the oligomer is preferably formed by solution polymerization, more preferably by solution polymerization of a substantially homogeneous mixture.

The (co)polymer is preferably formed by bulk polymerization in the absence of added organic solvents. Thus, in certain presently preferred exemplary embodiments, the composition is substantially free of any organic solvent. However, in some exemplary embodiments, solution polymerization may be carried out. The polymerization may also be carried out by other well known techniques such as suspension or emulsion polymerization.

Non-Reactive Diluents

Non-reactive diluent may be used in some exemplary embodiments to reduce the adiabatic temperature rise during reaction by absorbing a portion of the heat of reaction. Non-reactive diluents may also reduce the viscosity of the oligomer composition and/or advantageously affect the final properties of the oligomer composition. Advantageously, the non-reactive diluent can remain in the oligomer composition in its usable form.

Suitable non-reactive diluents are preferably non-volatile (that is, they remain present and stable under polymerization and processing conditions) and are preferably compatible (i.e. miscible) in the mixture. “Non-volatile” diluents typically generate less than 3% VOC (volatile organic content) during polymerization and processing. The term “compatible” refers to diluents that exhibit no gross phase separation from the base copolymer when blended in the prescribed amounts, and that, once mixed with the base copolymer, do not significantly phase separate from the base copolymer upon aging. Non-reactive diluents include, for example, materials which can raise or lower the glass transition temperature (T_{g}) of the oligomer composition, including tackifiers such as synthetic hydrocarbon resins and plasticizers such as phthalates.

The non-reactive diluent can also serve as a non-volatile “solvent” for incompatible mixtures of comonomers. Such incompatible comonomer mixtures typically require a volatile reaction medium, such as an organic solvent to promote effective copolymerization. Unlike volatile reaction media, the non-reactive diluent does not have to be removed from the oligomer composition.

Chain Transfer Agents

Chain transfer agents, which are well known in the polymerization art, may also be included to control the molecular weight or other polymer properties. The term “chain transfer agent” as used herein also includes “telogens”. Suitable chain transfer agents for use in the inventive process include but are not limited to those selected from the group consisting of carbon tetrabromide, hexanebromoethane, bromotrichloromethane, 2-mercaptoethanol, t-dodecylmercaptan, isooctylthioglycoate, 3-mercapto-1,2-propanediol, cumene, and mixtures thereof. Depending on the reactivity of a particular chain transfer agent and the amount of chain transfer desired, typically 0 to about 5 percent by weight of chain transfer agent is used, preferably 0 to about 0.5 weight percent, based upon the total weight of monomer(s).

Fillers

Useful fillers are preferably non-reactive such that they do not contain free radically reactive ethylenically unsaturated groups that can co-react with the comonomers of the base oligomer, or functionalities that significantly inhibit monomer polymerization or significantly chain transfer during the polymerization of monomers. Fillers can, for example, be used to reduce the cost of the final (co)polymer formulation.

Useful fillers include, for example, clay, talc, dye particles and colorants (for example, TiO₂ or carbon black), glass beads, metal oxide particles, silica particles, and surface-treated silica particles (such as Aerosil R-972 available from Degussa Corporation, Parsippany, N.J.). The filler can also comprise conductive particles (see, for example, U.S. Patent Application Pub. No. 2003/0051807) such as carbon particles or metal particles of silver, copper, nickel, gold, tin, zinc, platinum, palladium, iron, tungsten, molybdenum, solder or the like, or particles prepared by covering the surface of these particles with a conductive coating of a metal or the like.

It is also possible to use non-conductive particles of a polymer such as polyethylene, polystyrene, phenol resin, epoxy resin, acryl resin or benzoguanamine resin, or glass beads, silica, graphite or a ceramic, whose surfaces have been covered with a conductive coating of a metal or the like. Presently preferred fillers include, for example, hydrophobic fumed silica particles, electrically conductive particles, and metal oxide particles.

Appropriate amounts of filler will be familiar to those skilled in the art, and will depend upon numerous factors including, for example, the monomer(s) utilized, the type of filler, and the end use of the oligomer composition. Typically, filler will be added at a level of about 1% to about 50% by weight (preferably, about 2% to about 25% by weight), based upon the total weight of the reaction mixture.

### Construction Materials

The disclosed moisture-curable, semi-crystalline (meth)acrylic oligomer compositions can be used advantageously as a coating, for example as a primer or adhesion promoting layer, applied to a construction article substrate. In some exemplary embodiments, the substrate is selected as a construction material, particularly a construction material for use in exterior exposure applications exposed to weathering.

For example, the oligomer composition(s) may be used as a primer for pavement marking applications where high performance adhesion is required to asphalt or aggregate surfaces. Suitable pavement marking materials are disclosed in U.S. Pat. Nos. 7,342,056; 7,410,604; 7,458,694; 7,513,941; 7,579,293; 7,745,360; and 7,947,616.

The oligomer composition(s) can also be used as a primer for low surface energy adhesives, in particular when they are applied to high surface energy, hydrophilic surfaces. The oligomer composition(s) may also be used as a high performance moisture-curable additive for a variety of sealants, for example, caulks, grouts, and construction adhesives.

In some presently preferred embodiments, the disclosed moisture-curable, semi-crystalline (meth)acrylic oligomer composition(s) can serve as an exterior surface primer for roofing granules used in asphalt shingles, to improve the adhesion of the granules to the asphalt shingle material. Non-flat or sloped roofs typically use shingles coated with colored roofing granules adhered to the outer surface of the shingles. Such shingles are typically made of an asphalt base with the granules embedded in the asphalt. The roofing granules are used both for aesthetic reasons and to protect the underlying base of the shingle. In this application, water repellency, processibility and sustained weathering performance are critical and cannot be obtained by bending together a variety of commercially-available (co)polymers.

Bituminous sheet materials such as asphalt roofing shingles may be produced using the moisture-curable, semi-crystalline (meth)acrylic oligomer composition(s) of the present disclosure. Roofing shingles typically comprise materials such as felt, fiberglass, and the like. Application of a saturate or impregnant such as asphalt is essential to entirely permeate the felt or fiberglass base. Typically, applied over the impregnated base is a waterproof or water-resistant coating, such as asphaltum, upon which is then applied a surfacing of mineral granules, which completes the conventional roofing shingle.

Generally, a first coating is applied over at least a portion of the surface of substrate, which in this embodiment is a base roofing granule. A second coating is applied over at least a portion of first coating. Although the coatings are preferably continuous in most embodiments of the disclosure, incidental voids in either coating or in both coatings are acceptable in some aspects, such as when the overall coated construction surface possesses the necessary reflective properties. Additional layers also may be used.

Granule Substrate(s)

The substrate used for the granules of the present disclosure is inorganic. The inorganic substrate may be selected from any one of a wide class of rocks, minerals or recycled materials. Examples of rocks and minerals include basalt, diabase, gabbro, argillite, rhyolite, dacite, latite, andesite, greenstone, granite, silica sand, slate, nepheline syenite, quartz, or slag (recycled material). Preferably, the inorganic material is crushed to a particle size having a diameter in the range of about 300 micrometers (μm) to about 1800 μm.

Pigments

A presently preferred pigment for use as the overcoating (or primary coating) for the roofing granules is titanium dioxide (TiO₂). Other suitable pigments for the overcoating include V-9415 and V-9416 (Ferro Corp., Cleveland, Ohio) and Yellow 195 (the Shepherd Color Company, Cincinnati, Ohio), all of which are considered yellow pigments.

In some embodiments, the secondary or outermost coating includes pigments having enhanced NIR reflectivity. Suitable pigments for this coating include those described above, as well as: “10415 Golden Yellow”, “10411 Golden Yellow”, “10364 Brown”, “10201 Eclipse Black”, “V-780 IR BRN Black”, “10241 Forest Green”, “V-9248 Blue”, “V-9250 Bright Blue”, “F-5686 Turquoise”, “10202 Eclipse Black”, “V-13810 Red”, “V-12600 IR Cobalt Green”, “V-12650 Hi IR Green”, “V-778 IR Brn Black”, “V-799 Black”, and “10203 Eclipse Blue Black” (from Ferro Corp.); and Yellow 193, Brown 156, Brown 8, Brown 157, Green 187B, Green 223, Blue 424, Black 411, Black 10C₉₀₉ (from Shepherd Color Co.). These pigments also are useful in the undercoating.

The resulting coated granule of the present disclosure is preferably non-white in color. A white granule which would have acceptable solar reflectivity is not, however widely acceptable to the marketplace.

The coatings used to supply the pigments in both the under or primary coating, and the secondary or outer coating can have essentially the same constituents except for the pigment. The coatings are formed from an aqueous slurry of pigment, alkali metal silicate, an aluminosilicate, and an optional borate compound. The alkali metal silicate and the aluminosilicate act as an inorganic binder and are a major constituent of the coating. As a major constituent, this material is present at an amount greater than any other component and in some embodiments present at an amount of at least about 50 volume percent of the coating. The coatings from this slurry are generally considered ceramic in nature.

Silicate Binders

Aqueous sodium silicate is the preferred alkali metal silicate due to its availability and economy, although equivalent materials such as potassium silicate may also be substituted wholly or partially therefore. The alkali metal silicate may be designated as M₂O:SiO₂, where M represents an alkali metal such as sodium (Na), potassium (K), mixture of sodium and potassium, and the like. The weight ratio of SiO₂ to M₂O preferably ranges from about 1.4:1 to about 3.75:1. In some embodiments, ratios of about 2.75:1 and about 3.22:1 are particularly preferred, depending on the color of the granular material to be produced, the former preferred when light colored granules are produced, while the latter is preferred when dark colored granules are desired.

The aluminosilicate used is preferably a clay having the formula Al₂Si₂O₅(OH)₄. Another preferred aluminosilicate is kaolin, Al₂O ₃,2SiO₂.2H₂O, and its derivatives formed either by weathering (kaolinite), by moderate heating (dickite), or by hypogene processes (nakrite). The particle size of the clay is not critical to the disclosure; however, it is preferred that the clay contain not more than about 0.5 percent coarse particles (particles greater than about 0.002 millimeters in diameter). Other commercially available and useful aluminosilicate clays for use in the ceramic coating of the granules in the present disclosure are the aluminosilicates known under the trade designations “Dover” from Grace Davison, Columbia, Md. and “Sno-brite” from Unimin Corporation, New Canaan, Conn. The borate compound, when incorporated, is present at a level of at least about 0.5 g per kg of substrate granules but preferably not more than about 3 g per kg of substrate granules. The preferred borate compound is sodium borate available as Borax® (U.S. Borax Inc., Valencia, Calif.); however, other borates may be used, such as zinc borate, sodium fluoroborate, sodium tetraborate-pentahydrate, sodium perborate-tetrahydrate, calcium metaborate-hexahydrate, potassium pentaborate, potassium tetraborate, and mixtures thereof. An alternative borate compound is sodium borosilicate obtained by heating waste borosilicate glass to a temperature sufficient to dehydrate the glass.

### Method of Making Roofing Granules

The process for coating the granules of the present disclosure is generally described in U.S. Pat. Nos. 6,238,794 and 5,411,803. Inorganic substrate granules, preheated to a temperature range of about 125-140° C. in a rotary kiln or by equivalent means, are coated with the slurry to form a plurality of slurry-coated inorganic granules. The water flashes off and the temperature of the granules drops to a range of about 50-70° C. The slurry-coated granules are then heated for a time and at a temperature sufficient to form a plurality of ceramic-coated inorganic granules.

Typically and preferably the slurry-coated granules are heated at a temperature of about 400° C. to about 530° C. for a time ranging from about 1 to about 10 minutes. Those skilled in the art will recognize that shorter times may be used at higher temperatures. The heat typically and preferably emanates from the combustion of a fuel, such as a hydrocarbon gas or oil. The desired color of the granules may be influenced somewhat by the combustion conditions (time, temperature, % oxygen the combustion gases, and the like). The second or outer coating is then applied in a similar fashion.

### Unexpected Results and Advantages

The various moisture-curable, semi-crystalline (meth)acrylic oligomer composition(s), construction materials and methods of the present disclosure, in some exemplary embodiments, advantageously provide increased hydrophobicity, improved water repellency, ultra-low volatile organic compounds (VOC) performance at 100% solids, efficient manufacturing, easy handling, ease of coating using a wide variety of application methods, good shelf stability (compared to comparable dispersion-based compositions), and low cost.

The operation of various exemplary embodiments of the present disclosure will be further described with regard to the following non-limiting detailed examples. These examples are offered to further illustrate the various specific and preferred embodiments and techniques. It should be understood, however, that many variations and modifications may be made while remaining within the scope of the present disclosure.

### EXAMPLES

### Materials

Unless otherwise noted, all parts, percentages, ratios, etc. in the Examples and the rest of the specification are by weight. In addition, Table 1 provides abbreviations and a source for all materials used in the Examples below:

TABLE 1

| Abbreviation | Description | Source |
|---|---|---|
| VAZO 52 | 2,2′-azobis(2,4 dimethylpentanenitrile) | DuPont, |
| | | Wilmington, DE |
| VAZO 67 | 2,2′-azobis(2-methylbutanenitrile) | DuPont, |
| | | Wilmington, DE |
| VAZO 88 | 2,2′-azobis(cyclohexanecarbonitrile) | DuPont, |
| | | Wilmington, DE |
| IRGANOX 1010 | tetrakis(methylene(3,5-di-tert-butyl-4- | Ciba Specialty |
| | hydroxyhydrocinnamate))methane | Chemicals, |
| | | Tarrytown, NY |
| LUPERSOL 101 | 2,5-dimethyl-2,5 Di-(t-butylperoxy)hexane | Elf Atochem, |
| | | Philadelphia, PA |
| LUPERSOL 130 | 2,5-dimethyl-2,5-Di-(t-butylperoxy)hex-3-yne | Elf Atochem, |
| | | Philadelphia, PA |
| AA | (Meth)acrylic Acid | Dow Chemical, |
| | | Midland, MI |
| MMA | Methyl methacrylate | Rohm and Haas, |
| | | Philadelphia, PA |
| EtOAc | Ethyl acetate | EMD Chemicals, |
| | | Gibbstown, NJ |
| IPA | Isopropanol | JT Baker, |
| | | Center Valley, PA |
| ODA | Octadecyl acrylate | San Esters, |
| | | New York, NY |
| BHA | Behenyl Acrylate | Cognis, |
| | | Monnheim, Germany |
| IBOA | Isobornyl Acrylate | San Esters, |
| | | New York, NY |
| AN | Acrylonitrile | INEOS USA, Lima, OH |
| QMA | 2-(N,N-dimethylamino)ethylacrylate salt | Ciba Specialty Chemical, |
| | with methylchloride | Tarrytown, NY |
| DMAEMA | 2-(N,N-Dimethylamino)ethylacrylate, | 3M, St. Paul, MN |
| | salt with hexadecylbromide | |
| A-189 | (3-Mercaptopropyl)trimethoxysilane | Alfa Aesar, |
| | | Ward Hill, MA |
| IOA | Isooctylacrylate | 3M, St. Paul, MN |
| MEHQ | 4-methoxyphenol | Sigma-Aldrich, |
| | | St. Louis, MO |
| Q2-5211 | Q2-5211 Silicone Surfactant | Dow-Corning, |
| | | Midland, MI |
| IRGACURE 651 | 2,2-Dimethoxy-1,2-diphenylethan-1-one | Ciba Specialty Chemicals, |
| | | Tarrytown, NY |

### Test Methods

### Test Method for Assessing Water Repellency of Treated Roofing Granules

In some of the Examples below, compounds were used to treat roofing granules, and then the water repellency of those granules was tested according to the following protocol. A dropper bottle with fresh deionized or distilled water was prepared. Then 25 grams of the treated granules were poured into a conical pile and the apex of the pile was depressed with the round end of a test tube. Three drops of distilled water were dispensed from the dropper into the depression while simultaneously a stop watch was started. The time it took for the bead to break up and sink down through the granules was recorded.

### Test Method for Assessing Granule Asphalt Wettability of Treated Roofing Granules

In some of the Examples below, compounds were used to treat roofing granules, and then the asphalt wettability of those granules was tested according to the following protocol. Ten grams of treated granules were placed into 50 ml. of distilled water within a 100 ml beaker. Two grams of asphalt were measured out onto a spatula. The spatula containing the two grams of asphalt was placed into the granule/water mixture and used to stir the mixture for one minute, constantly attempting to coat the granules with the asphalt. While the whole mass of granules and asphalt is under water and after cessation of stirring, the percentage of total granule surface coated by asphalt was estimated visually. The mass of granules, asphalt, and water was allowed to stand for five minutes and the percentage of total granule surface coated by asphalt was again estimated visually. The lower of the two ratings was reported. Also reported was a visual estimate of percentage of asphalt covered granules and the percentage of loose granules lying on the bottom of the beaker. In Table 2 below, the two reported values are given in one column, separated by a dash.

### Test Method for Assessing Dust Production During Processing of Treated Roofing Granules

In some of the Examples below, compounds were used to treat roofing granules, and then the dust production of those granules was tested according to the following protocol. Fifty grams of granules to be tested were weighed out. A rubber stopper was place into a funnel, and the granules were poured into the funnel. A particle counter, commercially available from Met One Instruments of Grants Pass, Oreg., was set to Manual Mode. Simultaneously, the rubber stopper was removed from the funnel to allow granules flow down to the chamber of the instrument, and the Run button was pressed.

After the sample measurement was finished, the numeric value of the “Total Count Reading” at 0.3 microns was recorded as the raw dust reading. The isokinetic probe was then unplugged from the particle counter and the funnel was removed from the dust chamber. The granules were emptied from the chamber and the tubing, chamber, and funnel were cleaned with compressed air to remove excess dust. The dust chamber unit was then reassembled, and the isokinetic probe was reconnected to the sampling inlet.

The above procedure was repeated to obtain 3 dust readings per sample of treated granules. Also, the particle countered was purged for one minute and an assessment of the ambient dust reading was taken at least every nine readings. For convenience, a calculation was performed to convert the readings from the instrument into cm³, to wit: the value reported in the tables below=0.003*(instrument dust reading−instrument ambient dust reading)

### Synthesis of (Meth)Acrylic Oligomers

### Example 1

### (ODA/MMA/A-189 70/25/5 Weight Percent)

A solution of reactive monomers and solvents was prepared by adding them a glass bottle. Specifically, 10.5 grams of octadecyl acrylate (ODA), 3.8 grams of methyl methacrylate (MMA), 0.8 grams of (3-mercaptopropyl) trimethoxysilane (A-189), 0.15 grams of 2,2′-azobis(2-methylbutanenitrile) (VAZO 67), 24.5 grams of ethyl acetate (EtOAc), and 10.5 grams of isopropanol (IPA) were added. The ODA was heated to 65° C. in order to add it conveniently as a molten liquid, the other ingredients were added at room temperature. The mixture was gently shaken in order to prepare a homogenous solution. The bottle was purged with nitrogen, sealed and tumbled in a constant temperature water bath at 65° C. for 24 hours.

### Example 2

### ODA/MMA/A-189 60/30/10 Weight Percent

The procedure of Example 1 was repeated. The charges of components were as follows: 9.0 g ODA, 4.5 g MMA, 1.5 g A-189, 0.15 g VAZO 67, 24.5 g of EtOAc, and 10.5 g IPA.

### Example 3

### ODA/MMA/A-189 70/20/10 Weight Percent

The procedure of Example 1 was repeated. The charges of components were as follows: 10.5 g ODA, 3.0 g MMA, 1.5 g A-189, 0.15 g VAZO 67, 24.5 g of EtOAc, and 10.5 g IPA.

### Example 4

### ODA/AN/A-189 70/20/10 Weight Percent

The procedure of Example 1 was repeated, except that acrylonitrile (AN was added in place of the MMA. The charges of components were as follows: 10.5 g ODA, 3.0 g AN, 1.5 g A-189, 0.15 g VAZO 67, 24.5 g of EtOAc, and 10.5 g IPA.

Examples of (Meth)Acrylic Oligomers According to the Present Disclosure with Solventless Preparation in an Adiabatic Reactor

### Example 5

### ODA/MMA/A-189 (60/35/5) Weight Percent

An adiabatic reaction apparatus known as VSP2, equipped with a 316 stainless steel test can, both commercially available from Fauske and Associates Inc, of Burr Ridge IL, was charged with 70 grams of a mixture of ODA, MMA, and A-189 in a weight percent ratio of 60/35/5 respectively, and further with 0.1 pph of Irganox 1010, and 0.02 pph of VAZO 52. The reactor was sealed and purged of oxygen and then held at approximately 100 psig (793 kPa) of nitrogen pressure. The reaction mixture was heated to 60° C., and the reaction proceeded adiabatically. During this reaction, a peak temperature of approximately 100° C. was observed. When the reaction was complete, the mixture was cooled to below 50° C.

To 70.00 grams of the reaction product of the first step was added 0.02 pph of VAZO 52, 0.004 pph of VAZO 67, 0.006 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 145° C. was observed.

### Example 6

### ODA/MMA/A-189 (40/55/5) Weight Percent

The procedure of Example 5 was repeated, except for the following particulars: In the first reaction, the adiabatic reaction apparatus was charged with 70 grams of a mixture of ODA, MMA, and A-189 in a weight percent ratio of 40/55/5 respectively, and further with 0.1 pph of Irganox 1010, and 0.05 pph of VAZO 52. During the first reaction, a peak temperature of approximately 120° C. was observed.

To 70.00 grams of the reaction product of the first step was added 0.05 pph of VAZO 52, 0.01 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 120° C. was observed.

### Example 7

### ODA/IBOA/A-189 (60/35/5) Weight Percent

The procedure of Example 5 was repeated, except for the following particulars: In the first reaction, the adiabatic reaction apparatus was charged with 70 grams of a mixture of ODA, isobornyl acrylate (IBOA), and A-189 in a weight percent ratio of 60/35/5 respectively, and further with 0.1 pph of Irganox 1010, and 0.001 pph of VAZO 52. During the first reaction, a peak temperature of approximately 90° C. was observed.

To 70.00 grams of the reaction product of the first step was added 0.018 pph of VAZO 52, 0.004 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 108° C. was observed.

### Example 8

### ODA/IBOA/A-189 (40/55/5) Weight Percent

The procedure of Example 5 was repeated, except for the following particulars: In the first reaction, the adiabatic reaction apparatus was charged with 70 grams of a mixture of ODA, IBOA, and

A-189 in a weight percent ratio of 40/55/5 respectively, and further with 0.1 pph of Irganox 1010, and 0.001 pph of VAZO 52. During the first reaction, a peak temperature of approximately 112° C. was observed.

To 70.00 grams of the reaction product of the first step was added 0.018 pph of VAZO 52, 0.004 pph of VAZO 67, 0.006 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 107° C. was observed.

### Example 9

### ODA/MMA/A-189 (60/35/5) weight percent

The procedure of Example 5 was repeated, except for the following particulars: In the first reaction, the adiabatic reaction apparatus was charged with 70 grams of a mixture of ODA, MMA, and A-189 in a weight percent ratio of 60/35/5 respectively, and further with 0.1 pph of Irganox 1010, and 0.04 pph of VAZO 52. During the first reaction, a peak temperature of approximately 109° C. was observed.

To 70.00 grams of the reaction product of the first step was added 0.05 pph of VAZO 52, 0.01 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 111° C. was observed.

### Example 10

### BHA/MMA/A-189 (40/55/5) Weight Percent

The procedure of Example 5 was repeated, except for the following particulars: In the first reaction, the adiabatic reaction apparatus was charged with 70 grams of a mixture of behenyl acrylate BHA, MMA, and A-189 in a weight percent ratio of 40/55/5 respectively, and further with 0.1 pph of Irganox 1010, and 0.04 pph of VAZO 52. During the first reaction, a peak temperature of approximately 109° C. was observed.

To 70.00 grams of the reaction product of the first step was added 0.05 pph of VAZO 52, 0.01 pph of VAZO 67, 0.01 pph of VAZO 88, 0.006 pph of LUPERSOL 101, and 0.008 of LUPERSOL 130. (These components were added as a 0.7 gram solution dissolved in ethyl acetate). The reactor was again sealed and purged of oxygen and held at 100 psig (793 kPa) nitrogen pressure. The reaction mixture was heated to 60° C. and the reaction proceeded adiabatically. During this reaction, a peak temperature of approximately 145° C. was observed.

Examples of (Meth)Acrylic Oligamers with Radiation Initiated Preparation in a Pouch

### Example 11

### ODA/MMA/A-189 (60/35/5) Weight Percent

A 70 gram quantity of a mixture of ODA, MMA, and A-189 in a weight percent ratio of 60/35/5 respectively, and further with 0.15 pph of IRGACURE 651 was filled into a 4.4 cm×9.5 cm bag. The filled bag was then heat sealed at the top and in the cross direction through the monomer-filled region to form individual pouches of approximately 20 ml each of the mixture. The filled pouches were placed in a water bath that was maintained at 30° C. and were exposed to UV radiation with an irradiance of 4.5 mW/cm² for 20 minutes. At the end of the exposure, the pouches were removed from the water bath, dried and opened using a razor blade to release the oligomers formed by reaction of the mixture.

### Example 12

### ODA/MMA/A-189 (40/55/5) Weight Percent

The procedure of Example 5 was repeated, except for the following particulars: The pouch was charged with 70 grams of a mixture of ODA, MMA, and A-189 in a weight percent ratio of 40/55/5 respectively, and further with 0.1 pph of Irganox 1010.

### Example 13

### ODA/IBOA/A-189 (60/35/5) Weight Percent

The procedure of Example 5 was repeated, except for the following particulars: The pouch was charged with 70 grams of a mixture of ODA, IBOA, and A-189 in a weight percent ratio of 60/35/5 respectively, and further with 0.1 pph of Irganox 1010.

### Example 14

### ODA/IBOA/A-189 (40/55/5) Weight Percent

The procedure of Example 5 was repeated, except for the following particulars: The pouch was charged with 70 grams of a mixture of ODA, IBOA, and A-189 in a weight percent ratio of 40/55/5 respectively, and further with 0.1 pph of Irganox 1010.

### Materials Tested for Roofing Granule Applications

The following materials are used in the roofing granule examples: Sodium silicate solution (39.4% solids, 2.75 ratio SiO₂ to Na₂O) available from PQ Corp., Valley Forge, Pa.

Kaolin clay (available as Snobrite™ from Unimin Corporation, New Canaan, Conn., typical composition: 45.5% SiO₂, 38.0% A1203, 1.65% TiO₂ and small amounts of Fe₂O₃, CaO, MgO, K₂O and Na₂O).

Borax (Sodium Borate, 5 Mol, typical composition: 21.7% Na₂O, 48.8% B₂O₃, and 29.5% H₂O) available from U.S. Borax, Boron, Calif.

Titanium dioxide (Tronox® CR-800, typical composition: 95% TiO₂, alumina treated) available from the Kerr-McGee Corporation, Hamilton, Miss.

Pigments (10411 Golden Yellow, 10241 Forest Green, V-3810 Red, V-9250 Bright Blue) available from Ferro Corporation, Cleveland, Ohio.

Grade #11 uncoated roofing granules (quartz lattite/dacite porphyry) (available from 3M Company, St. Paul, Minn.) specified by the following ranges (as per ASTM D451) summarized in Table 2.

### Granule Coating Method

The slurry components indicated in Table 3 were combined in a vertical mixer. 1000 parts by weight of substrate were pre-heated to 90-95° C. and then combined with the indicated amount of slurry in a vertical or horizontal mixer. Example 1 used Grade #11 uncoated roofing granules as the substrate. Examples 2-4 used granules produced as in example 1 as the substrate. The slurry coated granules were then fired in a rotary kiln (natural gas/oxygen flame) reaching the indicated temperature over a period of about 10 minutes. Following firing, the granules were allowed to cool to room temperature.

TABLE 2

| U.S. | Nominal | | % Retained | | % Retained | |
|---|---|---|---|---|---|---|
| Sieve No. | Opening | | Minimum | Maximum | Target | Typical |
| 8 | 2.36 | mm | 0 | 0.1 | — | — |
| 12 | 1.70 | mm | 4 | 10 | 8 | — |
| 16 | 1.18 | mm | 30.0* | 45.0* | — | 37.5 |
| 20 | 850 | μm | 25.0* | 35.0* | — | 30 |
| 30 | 600 | μm | 15.0* | 25.0* | — | 20 |
| 40 | 425 | μm | 2.0* | 9.0* | — | 5.5 |
| −40 | −425 | μm | 0 | 2 | 1 | — |

*Typical Range

The treated granules were then tested for water repellency, asphalt wettability, and dust production according to the protocols described in Test Methods above. The results of these tests are presented in Table 3.

TABLE 3

| | | Treatment | | | |
|---|---|---|---|---|---|
| | Sample | Level | | | |
| | Description | (lbs | | | |
| | (weight | Sample/ | | | |
| | percentage | Ton | Water | Asphalt | Dust |
| Example | ratio) | Granules) | Repellency | Wettability | (Parts/cc) |
| 1 | ODA/MMA/ | 1.0 lb/ton | 60+ min | 95-0 | 216 |
| | A-189 | | | | |
| | (70/25/5) | | | | |
| 1 | ODA/MMA/ | 0.5 lb/ton | 60+ min | 85-0 | |
| | A-189 | | | | |
| | (70/25/5) | | | | |
| 2 | ODA/MMA/ | 1.0 lb/ton | 60+ min | 95-0 | 224 |
| | A-189 | | | | |
| | (60/30/10) | | | | |
| 2 | ODA/MMA/ | 0.5 lb/ton | 60+ min | 95-0 | |
| | A-189 | | | | |
| | (60/30/10) | | | | |
| 3 | ODA/MMA/ | 1.0 lb/ton | 60+ min | 100-0 | 241 |
| | A-189 | | | | |
| | (70/20/10) | | | | |
| 3 | ODA/MMA/ | 0.5 lb/ton | 60+ min | 95-0 | |
| | A-189 | | | | |
| | (70/20/10) | | | | |
| 4 | ODA/AN/ | 1.0 lb/ton | 60+ min | 100-0 | 387 |
| | A-189 | | | | |
| | (70/20/10) | | | | |
| 5 | ODA/MMA/ | 1.0 lb/ton | 60+ min | 95-0 | 70 |
| | A-189 | | | | |
| | (60/35/5) | | | | |
| 6 | ODA/MMA/ | 1.0 lb/ton | 60+ min | 100-0 | 172 |
| | A-189 | | | | |
| | (40/55/5) | | | | |
| 7 | ODA/IBOA/ | 1.0 lb/ton | 60+ min | 85-0 | 76 |
| | A-189 | | | | |
| | (60/35/5) | | | | |
| 8 | ODA/IBOA/ | 1.0 lb/ton | 60+ min | 100-0 | 80 |
| | A-189 | | | | |
| | (40/55/5) | | | | |
| 9 | ODA/MMA/ | 1.0 lb/ton | 60+ min | 100-0 | 92 |
| | A-189 | | | | |
| | (40/55/5) | | | | |
| 10 | BHA/MMA/ | 1.0 lb/ton | 60+ min | 95-0 | 56 |
| | A-189 | | | | |
| | (40/55/5) | | | | |

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

We claim:

1. A composition comprising at least one moisture-curable, semi-crystalline (meth)acrylic oligomer represented by the formula: 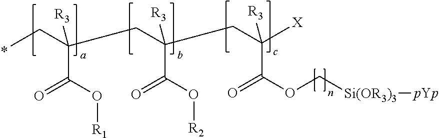
wherein:
R₁ is independently a C₁₆ to C₄₀ alkyl group;
R₂ is independently a C₁₆ to C₄₀ alkyl group;
each R₃ is independently a methyl, ethyl, or isopropyl group;
X is a chain transfer agent as defined further below;
Y is independently selected to be a methyl, ethyl, or isopropyl group;
a, b and c are each independently selected to be an integer of at least 10, and a+b+c≦1500;
n≧1; and
p is 0, 1, 2, or 3.
